(19) United States
(12) Patent Application Publication
(10) Pub. No.: US 2007/0226612 A1
(43) Pub. Date: Sep. 27, 2007

(54) SERVER-SIDE HTML CUSTOMIZATION BASED ON STYLE SHEETS AND TARGET DEVICE

(75) Inventor: Yudong SUN, Gilroy, CA (US)

Correspondence Address: SUGHRUE MION, PLLC, 2100 PENNSYLVANIA AVENUE, N.W., SUITE 800, WASHINGTON, DC, 20037, US

(73) Assignee: INTERNATIONAL BUSINESS MACHINES CORPORATION, Armonk, NY (US)

(21) Appl. No.: 11/754,886

(22) Filed: May 29, 2007

Related U.S. Application Data
(63) Continuation of application No. 09/512,560, filed on Feb. 24, 2000, now abandoned.

(51) Int. Cl. G06F 15/00

(52) U.S. Cl. 715/526

(57) ABSTRACT

A request reception module receives a request for an document stored within document server. A parsing module parses the document to generate therefrom a corresponding document object model (DOM) including at least one object. A style sheet access module obtains a style sheet including at least one rule directed to a target device for displaying the document. An style sheet application module applies the at least one rule of the style sheet to the DOM. A flattening module flattens the DOM to generate therefrom a corresponding transformed document. A transmission module transmits the transformed document to a requesting client program.

### BACKGROUND OF THE INVENTION

1. Field of the Invention

The present invention relates generally to techniques for processing a hypertext markup language (HTML) document. More particularly, the present invention relates to a system and method for server-side HTML customization based on style sheets and a target device.

2. Identification of Copyright

A portion of the disclosure of this patent document contains material subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

3. Relevant Technology

The World Wide Web (hereinafter “the Web”) is a collection of Internet-accessible servers from which specially formatted documents may be retrieved and displayed by Web browsers, such as Netscape Navigator™ and Microsoft Internet Explorer™. Currently, the hypertext markup language (“HTML”) is the most common authoring language for creating Web documents, also known as Web pages. A Web page is identified by a uniform resource locator (“URL”), which is used by a Web browser to locate and display a particular Web page.

Web browsers are now found in a variety of target devices, some of which are not capable of displaying every possible Web page. For example, a personal data assistant (PDA) is a handheld device that often includes a Web browser. However, a PDA is typically limited to displaying a few lines of text, and may not be able to display images or other graphical objects. As such, specially modified Web pages are typically required for PDAs.

In addition, some target devices have bandwidth limits for accessing the Internet. Wireless devices, for instance, such as Web-enabled cellular phones, are not capable of rapidly processing large Web pages. Accordingly, specially modified versions of Web pages are also desirable in the context of limited-bandwidth target devices.

Unfortunately, providing target device-specific versions of Web pages usually means providing separate Web pages identified by different URLs, which is problematic for a number of reasons. For example, a Web page developer would need to create and maintain (e.g. update) several different Web pages, resulting in increased costs and the possibility of inconsistent versions. Moreover, separate indexes and links would need to be created for Web pages corresponding to various target devices, greatly increasing the sizes of current indexes and Web pages.

Various techniques have been developed for dynamically customizing a Web page for display by different systems. For example, style sheets allow Web page developers to define how various HTML elements appear in the context of one or more Web pages. An element is a fundamental component of the structure of a HTML document, and may include, for example, a table, a paragraph, a list, an in-line image, and the like.

Each element may have an associated style, including one or more formatting parameters that dictate how the element is to be displayed by a Web browser. For example, a style may include parameters directed to margins, alignment, color, size, and the like.

Once created, a style sheet may be applied to one or more Web pages. In the case of “cascading” style sheets (CSS), multiple style sheets may be applied to the same Web page. CSS is a well known standard developed by W3C. Currently, CSS is not supported by all Web browsers, although the standard is growing in popularity.

A style sheet may be linked to an HTML document by means of a LINK element:

<HEAD>
<LINK REL=STYLESHEET HREF=“style.css” TYPE=“text/css”>
</HEAD>

External data files containing style information are typically identified by a “.css” extension, e.g., “style.css.”

A style sheet typically includes one or more rules, which define the styles to be applied to various elements or element types before the document is displayed. A rule typically includes at least one selector and at least one style to be attached to that selector. For example, in the rule, P {font-size: 10pt}, the selector, P, is referred to as a “type” selector, and the style declaration, {font-size: 10pt}, represents the style to be associated with every HTML element of the type, P (the “paragraph” element).

Style sheets are normally processed on the “client side,” i.e. by a Web browser, rather than on the “server side,” i.e. by a Web server. The reason for this distinction lies in the fact that Web browsers include parsers, which parse the Web page into a suitable data structure, such as a parse tree. The complex manipulations required for style processing must be performed on a parse tree or the like, and parsing is a normal step in displaying a Web page by a Web browser.

Web servers, on the other hand, do not conventionally parse Web pages, as such is not required to deliver (serve) Web pages. Likewise, Web servers do not normally include parsers. As a result, conventional Web severs are incapable of processing style sheets.

Unfortunately, many Web browsers do not support style sheet processing. For example, a PDA typically has a limited memory and central processing unit (CPU). Accordingly, PDA-based Web browsers are not able to process style sheets. Likewise, many older Web browsers do not support style sheets, since the technology is relatively new and the standards are still in flux.

Accordingly, what is needed is a system and method for server-side HTML customization. What is also needed is a system and method for server-side HTML customization based on style sheets and a target device. Moreover, what is also needed is a system and method for maintaining one version of an HTML document for various types of target devices with different capabilities.

### SUMMARY OF THE INVENTION

The present invention solves many or all of the foregoing problems by providing a system and method for server-side HTML customization based on style sheets and a target device.

In one aspect of the invention, a request reception module may receive a request for an document stored within document server. The document may be encoded in the hypertext markup language (HTML) and may include one or more HTML elements.

After the request is received, a parsing module may parse the requested document to generate therefrom a corresponding document object model (DOM) including at least one object. Each HTML element of the document typically corresponds to one objects of the DOM.

After the document is parsed, a style sheet access module may obtain a style sheet including at least one rule directed to a target device. In one embodiment, a target device identification module may identify the target device, and a style sheet identification module may identify at least one rule of a style sheet corresponding to the identified target device. In various embodiments, a single style sheet may contain rules for different target devices.

In another aspect of the invention, a style sheet application module may apply the identified style sheet rules to the DOM, after which a flattening module may flatten the DOM to generate therefrom a corresponding transformed document.

In one embodiment, the style sheet may be included within a separate portion of the document. In alternative embodiments, however, the style sheet and the document may comprise logically separate data files.

In yet another aspect of the invention, a transmission module may transmit the transformed document to a requesting client program. In various embodiments, the client program may include a Web browser.

These and other objects, features, and advantages of the present invention will become more fully apparent from the following description and appended claims, or may be learned by the practice of the invention as set forth hereinafter.

### BRIEF DESCRIPTION OF THE DRAWINGS

The present invention is more fully disclosed in the following specification, with reference to the accompanying drawings, in which:

FIG. 1 is a schematic block diagram of a computer system suitable for hosting a plurality of software modules according to an embodiment of the invention;

FIG. 2 is a schematic block diagram of a system for server-side customization of a hypertext markup language (HTML) document based on style sheets and a target device according to an embodiment of the invention;

FIG. 3 is schematic flowchart of a method for server-side HTML customization based on style sheets and a target device according to an embodiment of the invention;

FIG. 4 is an illustration of an HTML document according to an embodiment of the invention;

FIG. 5 is an illustration of a Document Object Model (DOM) according to an embodiment of the invention;

FIG. 6 is an illustration of a style sheet according to an embodiment of the invention;

FIG. 7 is an illustration of a transformed DOM according to an embodiment of the invention;

FIG. 8 is an illustration of a transformed HTML document according to an embodiment of the invention.

### DETAILED DESCRIPTION OF THE PREFERRED EMBODIMENTS

Certain presently preferred embodiments of the invention are now described with reference to the Figures, where like reference numbers indicate identical or functionally similar elements. The components of the present invention, as generally described and illustrated in the Figures, may be implemented in a variety of configurations. Thus, the following more detailed description of the embodiments of the system and method of the present invention, as represented in the Figures, is not intended to limit the scope of the invention, as claimed, but is merely representative of presently preferred embodiments of the invention.

Throughout the following description, various system components are referred to as “modules.” In certain embodiments, the modules may be implemented as software, hardware, firmware, or any combination thereof.

For example, as used herein, a module may include any type of computer instruction or computer executable code located within a memory device and/or transmitted as electronic signals over a system bus or network. An identified module may include, for instance, one or more physical or logical blocks of computer instructions, which may be embodied within one or more objects, procedures, functions, or the like.

The identified modules need not be located physically together, but may include disparate instructions stored at different memory locations, which together implement the described logical functionality of the module. Indeed, a module may include a single instruction, or many instructions, and may even be distributed among several discrete code segments, within different programs, and across several memory devices.

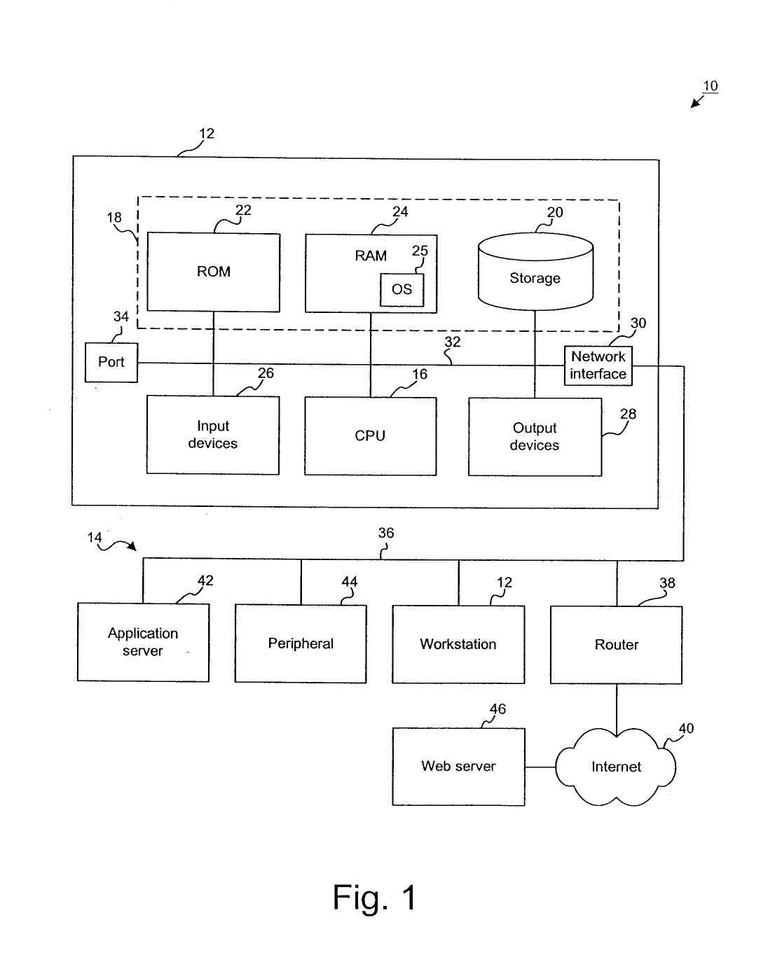

FIG. 1 is a schematic block diagram of a computer system 10 in which a plurality of software modules may be hosted on one or more computer workstations 12 connected via a network 14. The network 14 may include a wide area network (WAN) or local area network (LAN) and may also include an interconnected system of networks, one particular example of which is the Internet.

A typical computer workstation 12 may include a central processing unit (CPU) 16. The CPU 16 may be operably connected to one or more memory devices 18. The memory devices 18 are depicted as including a non-volatile storage device 20 (such as a hard disk drive or CD-ROM drive), a read-only memory (ROM) 22, and a random access memory (RAM) 24.

The computer workstation 12 may operate under the control of an operating system (OS) 25, such as OS/2®, WINDOWS NT®, WINDOWS®, UNIX®, and the like. In various embodiments, the OS 25 provides a graphical user interface (GUI).

The computer workstation 12 may also include one or more input devices 26, such as a mouse and/or a keyboard, for receiving inputs from a user. Similarly, one or more output devices 28, such as a monitor and/or a printer, may be provided within, or be accessible from, the computer workstation 12.

A network interface 30, such as an Ethernet adapter, may be provided for coupling the computer workstation 12 to the network 14. Where the network 14 is remote from the computer workstation 12, the network interface 30 may include a modem, and may connect to the network 14 through a local access line, such as a telephone line.

Within any given computer workstation 12, a system bus 32 may operably interconnect the CPU 16, the memory devices 18, the input devices 26, the output devices 28, the network interface 30, and one or more additional ports 34, such as parallel and/or serial ports.

The system bus 32 and a network backbone 36 may be regarded as data carriers. Accordingly, the system bus 32 and the network backbone 36 may be embodied in numerous configurations, such as wire and/or fiber optic lines, as well as electromagnetic communication channels using visible light, infrared, and radio frequencies.

The computer workstations 12 may be coupled via the network 14 to one or more application servers 42, and/or other resources or peripherals 44, such as scanners, fax machines, and the like. External networks, such as the Internet 40, may be coupled to the network 14 through a router 38 or firewall.

In various embodiments, one or more Web servers 46 may be accessible to the workstations 12 via the Internet 40. A Web server 46 may be implemented using a workstation 12, as described above, including specialized software for delivering (serving) Web pages to Web browsers. A variety of Web server application programs are available, including public domain software from the National Center for Supercomputing Applications (NCSA) and Apache, as well as commercial packages from Microsoft, Netscape and others.

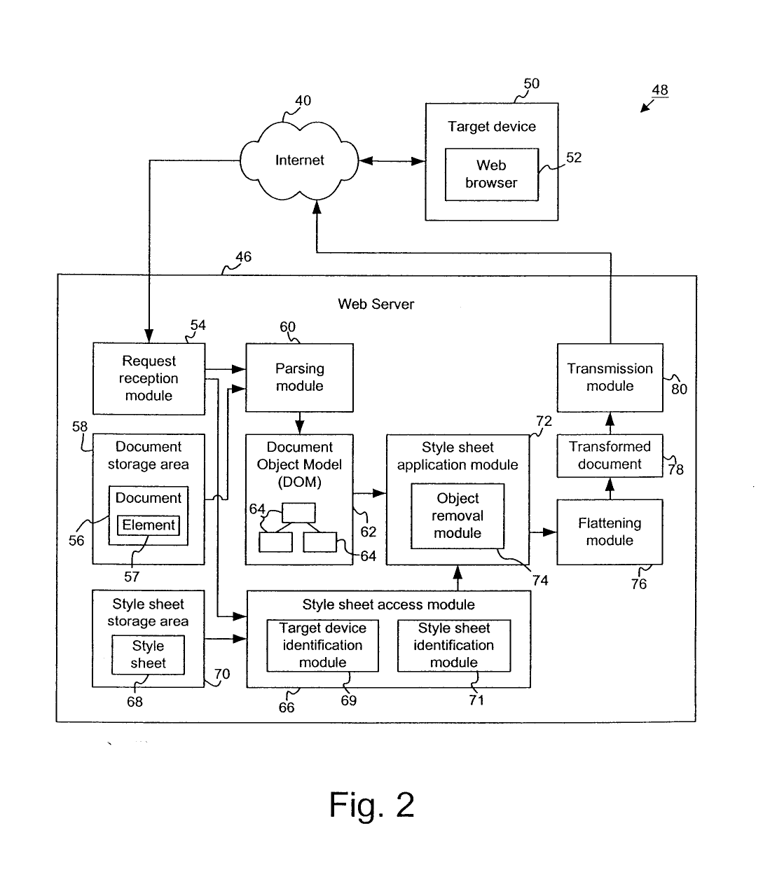

Referring now to FIG. 2, a system 48 for server-side HTML customization may include a Web server 46 and a target device 50. The target device 50 may be implemented using a workstation 12, which includes a Web browser 52, such as Netscape Navigator™ or Microsoft Internet Explorer™. The Web browser 52 may be configured to communicate with the Web server 46 via the hypertext transfer protocol (“HTTP”).

In various embodiments, the target device 50 may include a standard desktop computer, such as an IBM PC™ or compatible. In alternative embodiments, however, the target device 50 may include a Web-enabled personal data assistant (PDA), such as a PalmPilot™ VII, available from 3Com Corporation, or the like.

The Web server 46 is depicted as including a request reception module 54. In one embodiment, the request reception module 54 receives (from the Web browser 52) a request for a document 56 stored within a document storage area 58 of the Web server 46. The document 56 may be encoded in the hypertext markup language (“HTML”) and may include one or more HTML elements 57, as described more fully hereafter.

In one embodiment, the Web server 46 also includes a parsing module 60, commonly referred to as a “parser.” The parsing module 60 retrieves, in various embodiments, the requested document 56 and parses the document 56 to generate therefrom a corresponding Document Object Model (DOM) 62, often referred to as a “parse tree.” A DOM 62 is a tree-like, hierarchical data structure including one or more objects 64 that represent the various HTML elements 57 of the document 56.

In certain embodiments, the parsing module 60 is a conventional HTML parser. For example, both Netscape Navigator™ and Microsoft Internet Explorer™ include HTML parsers, which may be adapted, in various embodiments, for use within the Web server 46. In an alternative embodiment, a custom HTML parser may be used. Conventionally, however, a Web server 46 does not include a parsing module 60, since a document 56 is normally parsed only by a Web browser 52 at the time the document 56 is displayed.

The Web server 46 may also include a style sheet access module 66. In certain embodiments, the style sheet access module 66 is configured to retrieve a style sheet 68 (from a style sheet storage area 70) including one or more rules directed to a target device 50.

The style sheet access module 66 may include a target device identification module 69, which may identify the type or class of the target device 50. This may be accomplished, for example, based on platform information provided as part of a browser request. Typically, a browser request includes a browser name and version, as well as information about the platform, such as screen resolution.

The style sheet access module 66 may also include a style sheet identification module 71. According to various embodiment, a single style sheet 68 may include rules directed to different target devices 50. For example, rules directed to a PDA-type device may be identified within the style sheet 68 by @media handheld indicator or the like. Consequently, the style sheet identification module 71 may identify the rules of the style sheet 68 corresponding to the identified target device 50.

The Web server 46 may also include a style sheet application module 72, which applies the appropriate rules of the style sheet 68 to the DOM 62 of the document 56. Techniques for applying style sheets rules are well known in the art. For example, both Netscape Navigator™ and Microsoft Internet Explorer™ include style sheet application modules 72, which may be adapted, in various embodiments, for use within the Web server 46. In an alternative embodiment, however, a custom style sheet application module 72 may be used.

In one embodiment, the style sheet access module 66 includes an object removal module 74. Where, for instance, a rule within a style sheet 68 indicates a “NONE” display style, or similar designation, for an element 57 or element type, a corresponding object 64 within the DOM 62 is preferably removed.

For example, the rule, IMG {display: NONE}, indicates a “NONE” display style for the IMG (in-line image) element type. Accordingly, the object removal module 74 preferably removes the object(s) 64 of the DOM 62 corresponding to in-line image elements 57. This is advantageous, for instance, where a document 56 includes in-line images, but a target device 50, such as a PDA, cannot display such images.

The style sheets 68 and the Web documents 56 are depicted as logically separate data files, and may even be stored within separate storage areas 58, 70 of the Web server 46. In an alternative embodiment, a style sheet 68 may be included within a separate portion of the document 56. For example, the HTML elements 57 of the document 56 and the rules of the style sheet 68 may be stored within separate portions of a single logical data file.

The Web server 46 may also include a flattening module 76. In various embodiments, the flattening module 76 flattens the DOM 62 to generate therefrom a corresponding transformed document 78. As used herein, the term “flattening” refers to a process of converting the DOM 62 back into an equivalent HTML document 86 including one or more corresponding HTML elements 57. Techniques for flattening a DOM 62 are well known in the art. The resulting document 86 is designated as “transformed” because the style sheet application will be reflected in the HTML elements 57 of the transformed document 78.

In various embodiments, the Web server 46 may also include a transmission module 80. The transmission module 80 may send the transformed document 78 (via the Internet 40) to the Workstation 12, such that the document 86 may be displayed by the Web browser 52.

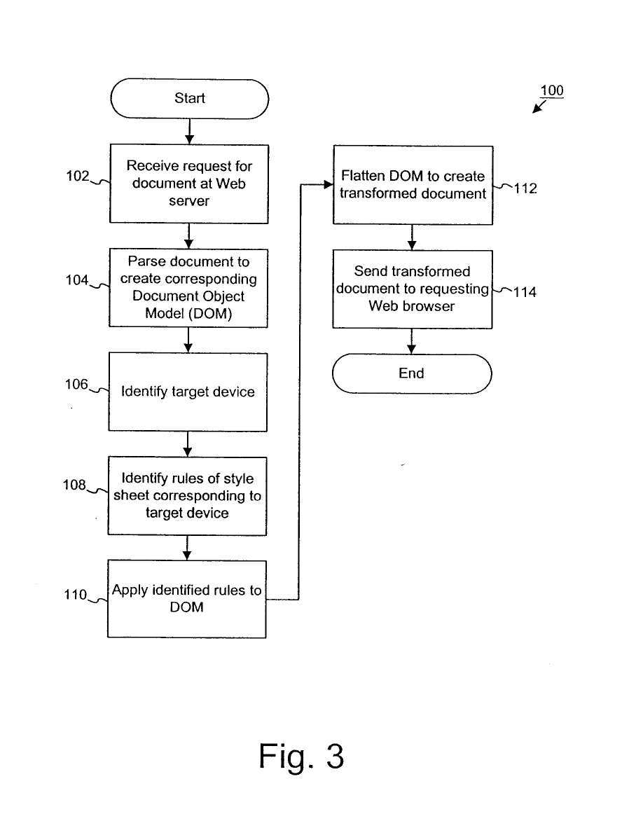

Referring now to FIG. 3, a schematic flowchart includes a method 100 for server-side HTML customization according to a presently preferred embodiment of the invention. The method 100 may begin by receiving 102, at a Web server 46, a request for a document 56.

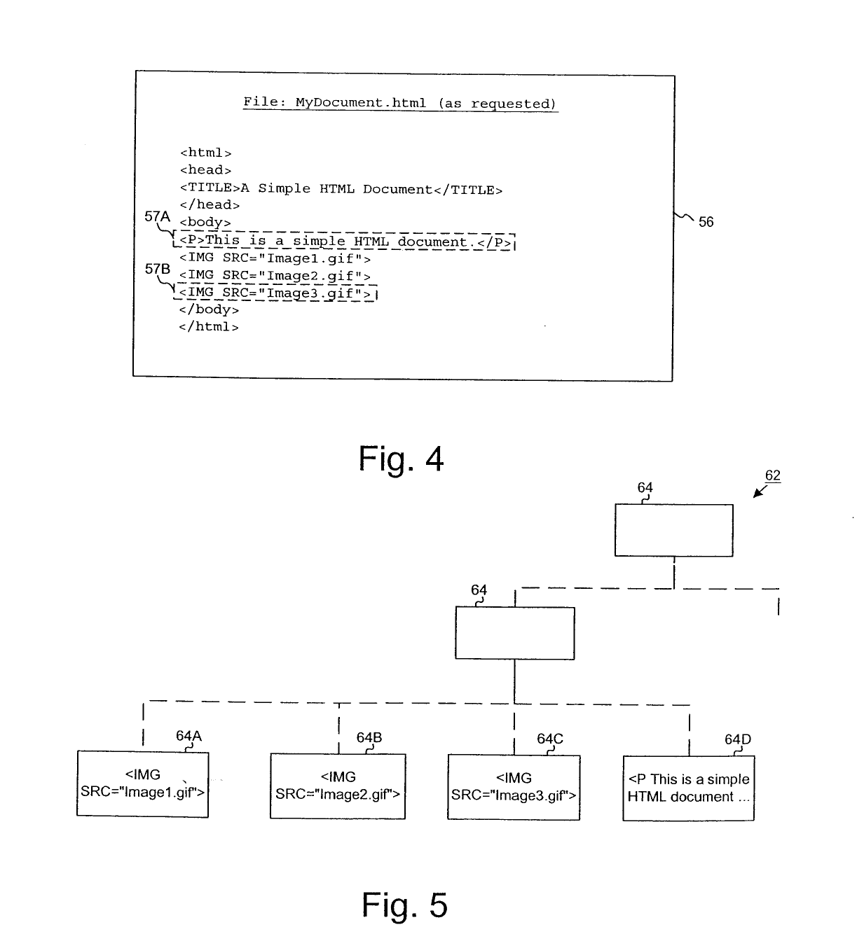

FIG. 4 illustrates an exemplary document 56 according to an embodiment of the invention. The document 56 may include one or more HTML elements 57, such as a paragraph element 57A and an image element 57B.

After the document request is received 102, the method 100 may continue by parsing 104 the document 56 to generate therefrom a corresponding Document Object Model (DOM) 62. As noted, a DOM 62 is a tree-like, hierarchical data structure including one or more objects 64 that represent the HTML elements 57 of the document 56. FIG. 5 illustrates a portion of a simplified DOM 62 corresponding to the document 56 of FIG. 4.

After the document 56 is parsed 104, the method 100 may continue by identifying 106 a target device 50 for displaying the document 56. As noted, the target device 50 may be based on platform information provided by a browser request.

After the target device 50 is identified 106, the method 100 may continue by identifying 108 one or more rules of a style sheet 68 directed to the identified target device 50. As noted, a single style sheet 68 may include sets of rules directed to different target devices 50. For example, a rule set directed to a PDA-type device may be identified by a @media handheld indicator or the like. Consequently, the style sheet identification module 71 may identify the rules of the style sheet 68 directed to the identified target device 50.

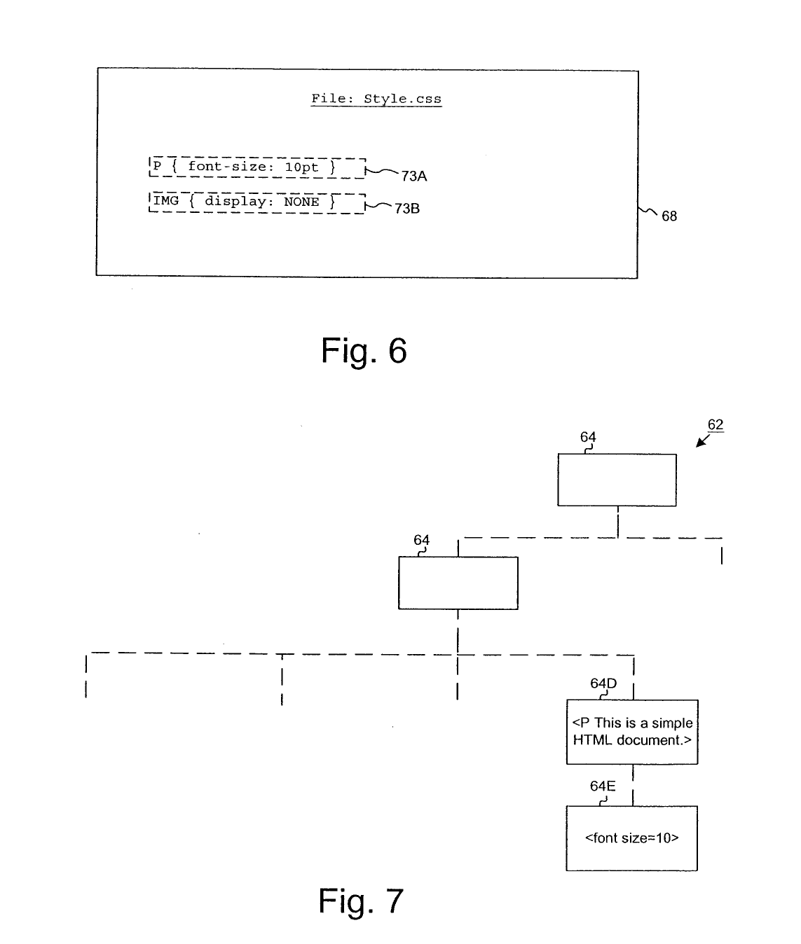

FIG. 6 illustrates an exemplary style sheet 68 for a PDA-type target device 50 according to an embodiment of the invention. The style sheet 68 may include any number of standard rules 72, such as rule-sets and at-rules (as defined in the CSS standard).

As previously explained, a PDA may not be capable of displaying images or other graphical objects. In addition, a PDA may be limited as to fonts, font sizes, and the like. Moreover, limited-bandwidth target devices 50, such as wireless devices, may require Web documents 56 that have reduced graphical content. The style sheet 68 may include one or more rules 72 for customizing a Web document 56 for a target device.

For example, a first rule 73A, i.e. P {font-size: 10pt} may set the font size for each paragraph element 57. Specifically, the rule 73A may set the font size to 10 points.

A second rule 73B, i.e. IMG {display: NONE}, may not include a typical style declaration, but may specify “NONE” display style or a similar designation. In various embodiments, a “NONE” display style causes the object removal module 74 to remove objects 64 corresponding to the element type specified in the rule 73.

After the style sheet 68 is identified, the method 100 may continue by applying 110 the identified style sheet rules 73 to the DOM 62. Each rule 73 of the style sheet 68 may be applied to the objects 64 of the DOM 62, which may result in the removal of certain objects 64 and the addition of others.

For example, as illustrated in FIG. 7, the rule 73A may add a new object 64E, corresponding to a <font size=10> element 57. By contrast, the rule 73B may cause objects 64A-C (IMG elements 57) of FIG. 5 to be deleted. After application of the style sheet 68, the DOM 62 may appear as shown in FIG. 7.

While the style sheet 68 and the document 56 are depicted herein as logically separate data files, the style sheet 68 may be included, in some instances, within a separate portion of document 56. For example, all of the rules 73 of the style sheet 68 may be located, as a group, at the beginning of the document 56:

```
<style>
    P { font-size: 10pt }
    IMG { display: NONE }
</style>
<html>
<head>
<TITLE>A Simple HTML Document</TITLE>
</head>
<body>
                                          . . .
```

In alternative embodiments, a single style sheet 68 may include portions corresponding to two or more target devices 50. For example, a style sheet 68 may include the following:

@media handheld
{
P { font-size: 10pt }
IMG { display: NONE }
}
@media tinyscreen
{
P { font-size: 12pt }
IMG { display: NONE }
}

In such an embodiment, the style sheet access module 66 may parse the style sheet 68 and extract the rules 73 corresponding to the identified target device 50.

After the rules 73 have been applied 110, the method 100 may continue by flattening 112 the DOM 62 to create a transformed document 78, which may then be sent 114 to the requesting Web browser 52 for display. As previously noted, the flattening process involves converting the DOM 62 back into an HTML document 86. Consequently, any transformations to the DOM objects 64 will be preferably reflected in the corresponding HTML elements 57 of the document 86.

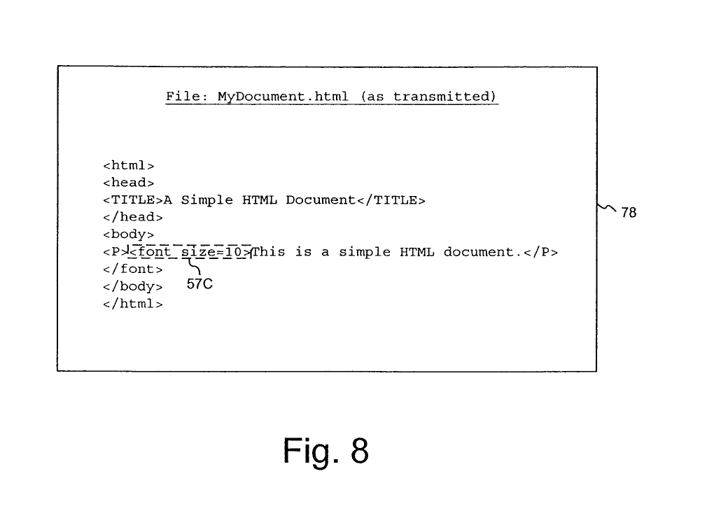

For example, FIG. 8 illustrates an exemplary transformed document 78 after flattening 116 the DOM 62 of FIG. 7. Comparing the transformed document 78 of FIG. 8 to the requested document 56 of FIG. 4 reveals that a new HTML element 57C is added, and the image elements 57 of FIG. 4, including element 57B, are deleted.

Based on the foregoing, the present invention offers a number of advantages not found in conventional approaches. Style sheets 68 are processed on the server side, which is advantageous for target device 50 that are not capable of style sheet processing, such as PDAs.

Moreover, the system and method of the present invention make it possible to maintain one version of a Web document 56 for a variety of target devices 50, each of which may have different capabilities. Thus, different target devices 50 may access a Web document 56 using the same URL, which minimizes development and maintenance costs and the need for multiple links for different target devices 50.

Even target devices 50 that are capable of processing style sheets 68 may benefit from the present invention, such as those with a limited bandwidth (e.g. wireless devices). Because style sheets 68 are conventionally applied by a Web browser 52, a wireless target device 50 must first retrieve a document 56 and a corresponding style sheet 68 before the style sheet 68 may be applied. Unfortunately, if the document 56 is large, the bandwidth has already been wasted.

By contrast, the system and method of the present invention apply style sheets 68 on the Web server 46. Server-side HTML customization results in a more compact document 56 that may be sent to a target device 50 over a limited-bandwidth network. Moreover, the need for bandwidth is further reduced because the style sheets 68 are never sent to the target device 50.

The present invention may be embodied in other specific forms without departing from its scope or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. Within a document server, a computer-implemented method for customizing a requested document comprising at least one hypertext markup language (HTML) element, the method comprising:
parsing the document to generate therefrom a corresponding document object model (DOM) including at least one object;
obtaining a style sheet including at least one rule directed to a target device;
applying the at least one rule of the style sheet to the DOM; and
flattening the DOM to generate therefrom a corresponding transformed document suitable for display by the target device.

2. The method of claim 1, wherein the style sheet comprises a cascading style sheet (CSS).

3. The method of claim 1, wherein the obtaining step comprises:
identifying a target device for displaying the document; and
identifying at least one rule of a style sheet directed to the identified target device.

4. The method of claim 3, further comprising:
receiving a request for a document from a client program.

5. The method of claim 4, wherein the client program comprises a Web browser.

6. The method of claim 1, wherein the style sheet includes rules directed to at least two different target devices.

7. The method of claim 1, wherein the style sheet is stored within a separate portion of the document.

8. The method of claim 1, wherein the style sheet and the document are stored as logically separate data files.

9. The method of claim 1, further comprising:
transmitting the transformed document to a client program.

10. The method of claim 1, the transforming step comprising:
removing at least one object of the DOM in response to an indication within the style sheet to remove a corresponding HTML element from the document.

11. A system for customizing a requested document comprising at least one hypertext markup language (HTML) element, the system comprising:
a parsing module configured to parse the document to generate therefrom a corresponding document object model (DOM) including at least one object;
a style sheet access module configured to obtain a style sheet including at least one rule directed to a target device;
a style sheet application module configured to apply the at least one rule of the style sheet to the DOM; and
a flattening module configured to flatten the DOM to generate therefrom a corresponding transformed document suitable for display by the target device.

12. The system of claim 11, wherein the style sheet comprises a cascading style sheet (CSS).

13. The system of claim 11, wherein the style sheet access module comprises:
a target device identification module configured to identify a target device for displaying the document; and
a style sheet identification module configured to identify at least one rule within a style sheet directed to the identified target device.

14. The system of claim 13, further comprising:
a request reception module configured to receive a request for a document from a client program.

15. The system of claim 14, wherein the client program comprises a Web browser.

16. The system of claim 11, wherein the style sheet includes rules directed to at least two different target devices.

17. The system of claim 11, wherein the style sheet is stored within a separate portion of the document.

18. The system of claim 11, wherein the style sheet and the document are stored as logically separate data files.

19. The system of claim 11, further comprising:
a transmission module configured to transmit the transformed document to a client program.

20. The system of claim 11, wherein the style sheet application module comprises:
an object removal module configured to remove at least one object of the DOM in response to an indication within the style sheet to remove a corresponding HTML element from the document.

21-30. (canceled)
